(19) United States
(12) Patent Application Publication
(10) Pub. No.: US 2006/0274923 A1
(43) Pub. Date: Dec. 7, 2006

(54) Monitoring image inspection

(75) Inventors: Scott Forster, London (GB); Alexander David France, Bedfordshire (GB)

Correspondence Address: SUGHRUE MION, PLLC, 2100 PENNSYLVANIA AVENUE, N.W., SUITE 800, WASHINGTON, DC, 20037, US

(73) Assignee: FUJIFILM ELECTRONIC IMAGING LTD.

(21) Appl. No.: 11/503,991

(22) Filed: Aug. 15, 2006

Related U.S. Application Data
(63) Continuation-in-part of application No. 11/149,871, filed on Jun. 10, 2005.

(30) Foreign Application Priority Data
Mar. 14, 2005 (GB) 0505232.9
May 27, 2005 (GB) 0510931.9

(51) Int. Cl. G06K 9/00

(52) U.S. Cl. 382/128

(57) ABSTRACT

A method of monitoring the inspection of a two dimensional digital image by a viewer using a digital image viewing device. The method comprises recording data defining versions of the digital image inspected by the viewer such that each recorded version can be reproduced.

### FIELD OF THE INVENTION

The invention relates to methods and systems for monitoring the inspection of a digital image by a viewer.

### DESCRIPTION OF THE PRIOR ART

The inspection of samples, particularly biological samples, by experts is a very complex process and requires significant expertise. Inspections of biological material are used to detect cell and tissue morphology across the areas of pathology, histology, cytology and haematology. In the past, in order to maximise the chances of correct diagnoses, samples have been inspected by more than one person. Furthermore, in order to train people to carry out accurate inspections, a supervisor or teacher will monitor a trainee as he or she inspects a sample.

The present methods are time consuming and require real-time monitoring of viewers of samples both for training purposes and in live situations.

In accordance with a first aspect of the present invention, a method of monitoring the inspection of a two dimensional digital image by a viewer using a digital image viewing device comprises recording data defining versions of the digital image inspected by the viewer such that each recorded version can be reproduced.

In accordance with a second aspect of the present invention, a digital image monitoring system for connection to a digital image viewing device comprises a memory for storing data defining versions of a two dimensional digital image inspected by the viewer using the digital image viewing device; and a processor for reproducing each recorded version of the digital image.

In this new invention, it is no longer necessary to monitor a viewer live and in real-time. Instead, it is possible, by recording the data defining versions of the two dimensional digital image inspected by the viewer, to reproduce the viewing session at a later time and/or remotely. Not only does this assist in the training of viewers by optimizing the supervisor's time but can also be used to check the performance of live inspections both to achieve further training and possibly for insurance purposes.

The image could be a single two dimensional image or one of a stack of two dimensional images.

Typically, a copy of the digital data used to reproduce the image to be viewed by the digital image viewer is also recorded, possibly in compressed form. This can be achieved by including an additional software component in the digital image viewing device processor which monitors the action of the digital image viewing device and when it detects that the viewer has instructed a different version of the image to be viewed, for example a magnified or zoomed version, it then copies the digital data generated by the viewing device to control its display and arranges for this to be recorded separately.

In addition, certain metadata may also be recorded including, for example, the viewer's identification, file name viewed, sample name, viewing start time, screenshot style recording of views, coordinates navigated around the file, any offset area displayed, locations of displayed images, colour management profile of the visual display unit, magnification of display, change of magnification, time spent at each location, finish time and any annotations, areas of interest, markers, areas deemed unsuitable for diagnosis or any other parameter that indicates the users performance (summarized as “user action events”).

The recording of the data could be carried out locally to the digital image viewing device but in a particularly convenient application of the invention, this takes place at a remote site. Communication with the remote site can be carried out using one or more of a local area network, the Internet, satellite, cable or PSTN network.

The method therefore can capture and record relevant “user action events” on a particular sample, including the sequence and timing of such events. This can then be stored with the original sample files providing a permanent record of the viewer's performance or sent for analysis by another individual. This analysis could be the viewing of each parameter individually or the display of a “real-time” reconstruction of the visual display of the action events performed by the user in sequence and asynchronously to the report. The tracing of the viewer's views gives a reconstruction of the route around the image used, including stopped locations and time, vectors of movement, zooming, magnification and actual screen views. This provides a method of recording and detailing what each viewer has performed in the process of viewing an image. For example, this mechanism could then be used to gather information to provide important feedback of what has/has not been examined during the viewing of a remote image. This could be used to quality control individuals that are not located within close proximity of the original sample.

It will be applicable for the institute or digital imaging user to prevent litigation on a particular sample if it is reviewed, especially with regard to viewing by microscopic samples by an external source.

It can be used in the assessment of technical staff, screeners, trainees or users who could actually be reviewed by the true performance in front of the sample. Teachers would have the ability to see where the student navigated around the sample, see what magnification they used and analyse the identifying process.

### BRIEF DESCRIPTION OF THE DRAWINGS

An example of the method and system according to the invention will now be described with reference to the accompanying drawing, in which:—

FIG. 1 is a schematic, block diagram of the system.

### DESCRIPTION OF THE EMBODIMENT

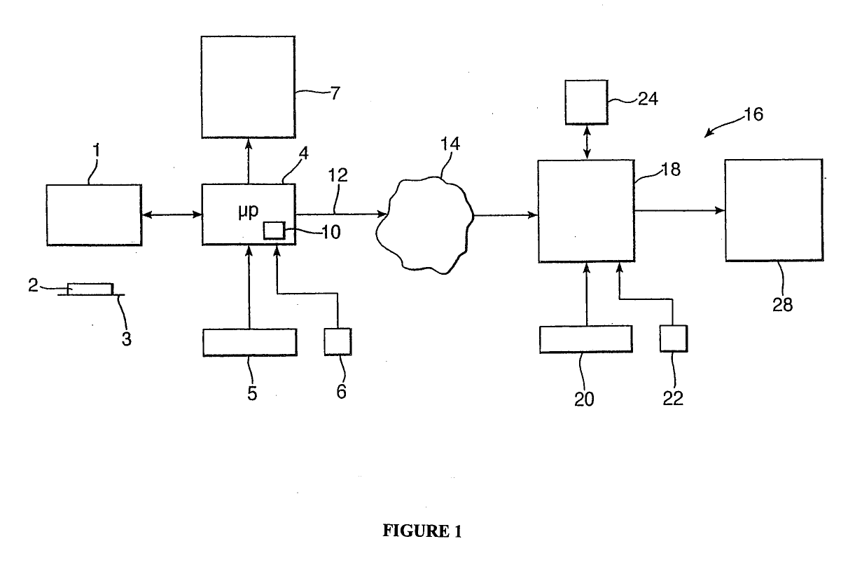

The digital image monitoring system shown in FIG. 1 comprises a digital microscope 1 for viewing a sample 2 on a support 3. Typically, the sample 2 is a biological sample such as a number of cells located on a microscope slide. The digital microscope 1, which is of conventional form, generates digital data defining the pixel content of a two dimensional image of the sample 2 and this data is fed to a microprocessor 4.

The microprocessor 4 is controlled by a viewer using a keyboard 5 and mouse 6 and is coupled with a visual display unit or other monitor display 7.

In use, a viewer, using the keyboard 5 and mouse 6, causes the microprocessor 4 to control operation of the microscope 1 so that the sample 2 can be viewed in different orientations and at different magnifications and zoom levels etc. Following each command from the viewer, a corresponding image will be displayed by the microprocessor 4 on the VDU 7. In this way, the viewer can inspect the sample from different angles and at different magnifications in order to detect aberrations in the sample.

As explained above, the invention is concerned with how to monitor the viewer's actions. This is achieved by providing a software module 10 in the microprocessor 4 which monitors the input signals from the viewer via the keyboard 5 and mouse 6 and when these cause the microprocessor 4 to generate a different version of the image of the sample on the display 7, cause a copy of the digital data supplied by the microprocessor 4 to the display 7 to be fed along an output line 12 to a communication network 14.

The data on the line 12 is addressed to a remote location 16, the network 14 comprising one or more of a local area network, the Internet, a PSTN, etc.

At the remote location 16 there is provided a microprocessor 18 controllable by an operator via a keyboard 20 and mouse 22. The microprocessor 18 automatically stores the incoming data from the microprocessor 4 in a store 24, typically after conventional data compression. The microprocessor 18 can then be controlled by the operator to extract the data from the store 24 corresponding to a particular view and to cause that view to be displayed on a local monitor 26. In this way, the operator at location 16 can reproduce the analysis steps performed by the viewer.

Typically, in addition to the image data, the microprocessor 18 will also store other metadata associated with each image. That metadata can include one or more of the viewer's identification, file name viewed, sample name, viewing start time, screenshot style recording of views, coordinates navigated around the file, any offset area displayed, locations of displayed images, colour management profile of the visual display unit, magnification of display, change of magnification, time spent at each location, finish time and any annotations, areas of interest, markers, areas deemed unsuitable for diagnosis or any other parameter that indicates the users performance (summarized as “user action events”).

We claim:

1. A method of monitoring the inspection of a two dimensional digital image by a viewer using a digital image viewing device, the method comprising recording data defining versions of the digital image inspected by the viewer such that each recorded version can be reproduced.

2. A method according to claim 1, further comprising recording metadata associated with each recorded version of the digital image.

3. A method according to claim 2, wherein the metadata comprises one or more of viewer's identification, image identification, viewing start time, viewing duration, viewing parameters such as magnification and viewing direction, colour management profile of device used by the viewer to view the digital image, and finish time.

4. A method according to claim 1, wherein the recorded data defines the colour content of pixels of the digital image.

5. A method according to claim 4, wherein the recorded data is a compressed version of the digital image being inspected.

6. A method according to claim 1, wherein the recording step is carried out at a remote location from the location of the viewer.

7. A method according to claim 6, wherein data is sent to the remote location via a local area network, the Internet, satellite, cable or PSTN network.

8. A method according to claim 1, wherein each new version of the digital image is defined with respect to previous versions by a change in the area of the image inspected and/or a change in the direction, zoom factor or magnification of the image.

9. A method according to claim 1, wherein the digital image is obtained from a biological sample.

10. A method according to claim 1, wherein the digital image viewing device is a microscope.

11. A digital image monitoring system for connection to a digital image viewing device, the system comprising a memory for storing data defining versions of a two dimensional digital image inspected by the viewer using the digital image viewing device; and a processor for reproducing each recorded version of the digital image.

12. A digital image processing system comprising a digital image monitoring system according to claim 11; and a digital image viewing device coupled with the digital image monitoring system.

13. A processing system according to claim 12, wherein the digital image viewing device comprises a microscope.
